(19) United States
(12) Patent Application Publication
(10) Pub. No.: US 2008/0074104 A1
(43) Pub. Date: Mar. 27, 2008

(54) Displaceable component including a position-defining element made of a magnetized elastomer

(75) Inventors: Marcus Sauer, Labenz (DE); Heiko Schumacher, Bad Oldesloe (DE)

Correspondence Address: VENABLE LLP, P.O. BOX 34385, WASHINGTON, DC, 20043-9998, US

(73) Assignee: Dichtungstechnik G. Bruss GmbH & Co. KG, Hoisdorf (DE)

(21) Appl. No.: 11/902,306

(22) Filed: Sep. 20, 2007

(30) Foreign Application Priority Data
Sep. 22, 2006 (DE) 10 2006 045 827.3

(51) Int. Cl. G01B 7/00

(52) U.S. Cl. 324/207.22

(57) ABSTRACT

A displaceable component includes a body having an axis and arranged for movement in at least one of an axial direction or a rotary direction about the axis. A position-defining element is fixed to the body and substantially comprising a magnetised elastomer. The position-defining element is arranged to be sensed by a sensor to determine at least one of an axial position, a rotary position or a rotary speed of the body.

### CROSS-REFERENCE TO RELATED APPLICATION

This application claims the priority of German Patent Application No: 10 2006 045 827.3, filed on Sep. 22, 2006, the subject matter of which is incorporated herein by reference. Each U.S. and foreign patent and patent application mentioned below is incorporated herein by reference.

### FIELD OF THE INVENTION

The invention relates to a displaceable component in, for example, a motor vehicle engine or gearbox, and more particularly to such a displaceable component that is moveable in an axially and/or rotary direction, and a positioning determining system for such a component.

### BACKGROUND OF THE INVENTION

To determine the axial position of a valve stem, it is known from German Patent document DE 44 38 059 C2 to form the valve stem from two parts that follow each other in the axial direction. Such parts are disclosed as consisting of materials of different electrical or magnetic conductivity and are joined with each other through friction welding. In the region of the joint, a coil that generates a magnetic field is arranged in a fixed location. Displacement of the joint is detectable with the coil based on induced currents or voltages. In addition to a considerable manufacturing expenditure connected with friction welding, the joint of the valve stem parts constitutes a weak point jeopardizing the fatigue durability.

Further, known systems for determining the axial position of a valve stem are based on the displacement of a pickup in a magnetic field. In the case of German Patent document DE 101 57 119 A1, the pickup is formed by a short circuit element of a material with low electrical resistance. According to German Patent document DE 102 14 685 A1, the valve stem has a saw tooth structure formed through recesses over an axial region, which upon axial movement changes the field strength curve of a magnetic field, which is detected with a magnetoresistive displacement transducer.

With a ring-shaped pickup of a rigid ferromagnetic or ferritic material according to German Patent document DE 201 15 060 U1, a dynamic load can change the magnetic characteristics of the material as a function of time, which can lead to interference signals. Based on this, it is proposed with German Patent document DE 202 09 369 U1 to embody the connection between the pickup and the tappet in a force-insulated manner by a connection layer of porous solder.

All of the systems for position determination described above are relatively complicated and therefore connected with high manufacturing expenditure.

### SUMMARY OF THE INVENTION

It is an object of the invention to provide a component with a position-defining element which, with low manufacturing expenditure, enables reliable position determination of the component even with dynamic loading.

The above and other objects are accomplished by the invention, wherein there is provide, according to one embodiment, a displaceable component, comprising: a body having an axis and arranged for movement in at least one of an axial direction and a rotary direction about the axis; and a position-defining element fixed to the body and substantially comprising a magnetised elastomer, the position-defining element being arranged to be sensed by a sensor to determine at least one of an axial position, a rotary position or a rotary speed of the body.

The position-defining element may be located in the displaceable component. The position-defining element may be, for example, a magnetizable elastomer element which results in a particularly simple construction with low manufacturing expenditure. Additionally, dynamic loads emanating from the component such as shocks and vibrations are dampened or absorbed through the elasticity of the rubber, as a result of which corresponding interfering influences are suppressed and reliable position determination, even under a dynamic continuous load, are ensured. An additional intermediate damping layer between the rubber element and the component is not required.

According to another embodiment of the invention, the position-defining elastomer (also referred to herein as “rubber”) element may be accommodated in a groove or recess provided in the component.

The position-defining rubber element may be, for example, vulcanised to the component. Alternatively a pre-fabricated rubber element may be attached through gluing and/or through rolling-in in a preferred groove accommodating the rubber element on the component.

In order to obtain a preferably strong magnetic field with a view to sound signal quality, it is advantageous to shape the position-defining rubber element under the influence of a corresponding magnetic field.

Through bipolar magnetizing of the elastomer element, the axial position of the component can be determined with a suitable sensor or pickup.

In addition to axial displacement, the component can also be rotated about the longitudinal axis. Such an application relates, for example, to a switching element (a so-called composite piston) in an automatic gearbox. Here, the invention enables adherence to high measuring accuracy despite the additional load resulting from the rotation of the shaft with high circumferential velocity.

In particular, for a component that is displaceable axially and/or rotationally, it is advantageous if the magnetization of the elastomer element enables determination of the rotary position, i.e. the position in a circumferential direction or the angle of rotation as well as the rotational velocity, if applicable. To this end, the magnetization of the rubber element may be multipolar along a circumferential direction of the component. In a more general way, the magnetization of the rubber element may vary along a circumferential direction of the component, i.e. the strength of the magnetization is not constant along the circumferential direction of the component. Alternatively, the magnetisable rubber element along the circumferential direction can be formed only by sections and alternate with non-magnetisable sections of the component, wherein in this case one or several rubber elements can be provided.

A screw-shaped arrangement of the rubber element around a longitudinal axis of the component permits the determination of both the axial position and also the angle of rotation and the rotating speed of the component.

### BRIEF DESCRIPTION OF THE DRAWINGS

In the following, the invention is explained by embodiments of the invention, making reference to the accompanying drawings.

FIG. 1 depicts a cross sectional view of a portion of a rod-shaped component in an internal combustion engine in an embodiment of the invention.

FIG. 2 depicts a side view of a portion of a rod-shaped component in an internal combustion engine in another embodiment of the invention.

FIG. 3 depicts a side view, in partial cross section, of a portion of a rod-shaped component in an internal combustion engine in a further embodiment of the invention.

FIG. 4 is a side view, in partial cross section, of a portion of a rod-shaped component in an internal combustion engine in another embodiment of the invention.

FIG. 5 is a schematic view, in partial cross section, of a shifting shaft in an automatic gearbox in another embodiment of the invention.

FIG. 6 depicts a side view of a portion of a rod-shaped component in an internal combustion engine in a further embodiment of the invention.

### DETAILED DESCRIPTION

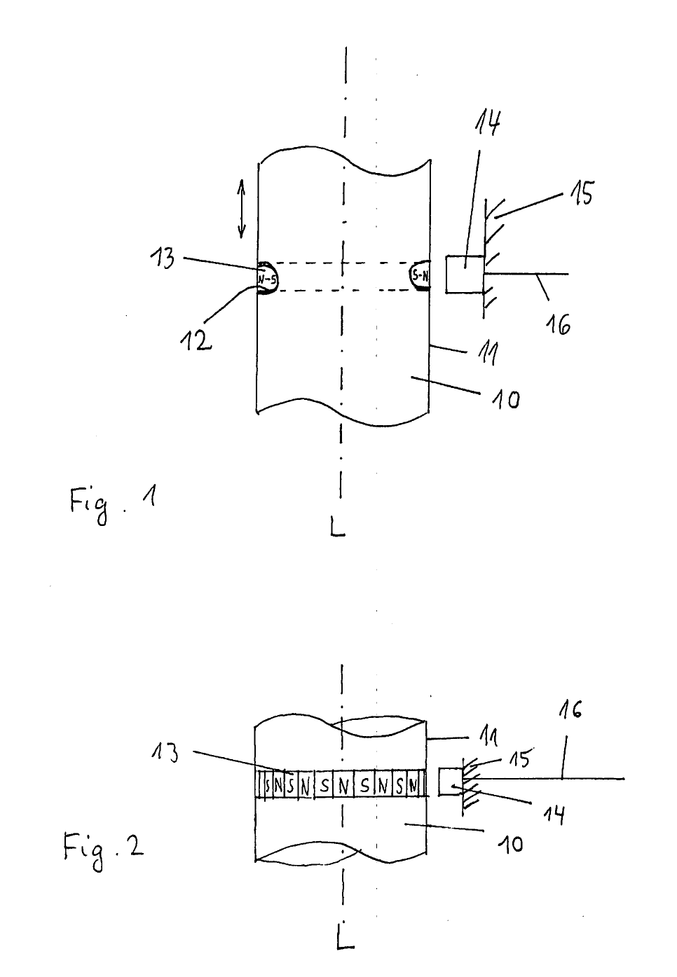

Referring to FIG. 1, there is shown an embodiment of the invention, including a rod 10, which may be, for example, a valve stem or tappet (cam follower) for a valve in a motor vehicle engine, or another component for an engine or gearbox of a motor vehicle. The rod 10 may be displaceable in a linear (axial) manner along the longitudinal axis L as indicated by the double arrow. The component 10 is typically made of metal.

A circumferential slot, recess or groove 12, which may completely or partially surround rod 10, is worked into the circumferential wall 11 of the rod 10. FIG. 1 shows a ring-shaped rubber element 13 arranged in the circumferential slot 12.

The rubber material of the rubber element 13 is magnetized. To this end, magnetizable particles, preferably ferrite particles, may be practically added to the rubber mixture during the manufacture of the rubber element 13. The magnetization may take place during the shaping of the rubber element 13 in order to obtain a preferably strong magnetization.

To sense the magnetic field, which emanates from the rubber element 13 and changes through the displacement along the longitudinal axis L, a suitable sensor 14 may be attached in a fixed position, for example, on a housing part 15 of the motor vehicle. The sensor 14 may comprise a coil or be another sensor suitable for sensing a changing magnetic field, for example a Hall sensor. Because of the displacement of the rod 10 along the longitudinal axis L, the distance between the rubber element 13 and the sensor 14 changes. As the distance between the rubber element 13 and the sensor 14 changes, the magnetic field where the sensor 14 is located may change. These changes in the magnetic field may be detected by the sensor 14 and the axial position of the rod 10 determined from this. To this end, a measuring signal generated by the sensor 14 may be directed via a signal line 16 to an electronic processing facility, for example a processor, which is not shown.

To sense the axial position, it is generally sufficient if the rubber element 13 is a dipole or the polarization is substantially constant over the entire circumference of the rod 10. As is shown in FIG. 1 the magnetizing axis of rubber element 13, for example, is orientated radially so that only one magnetization pole, here the north pole, is present over the entire circumference of the rod 10. It is also possible that the magnetizing axis is positioned in the circumferential surface of the rod 10, preferably parallel or vertically to the longitudinal axis L. In this case both poles are present in the circumferential surface (bi-directional magnetization).

Preferably, in the case of a shaft rotating around the longitudinal axis L, in addition to the sensing linear displacement, it is advantageous if the magnetization of the rubber element 13 enables sensing the rotational position or the angle of rotation, or, if applicable, the rotating speed of the rubber element 13 around the longitudinal axis L. In general, the magnetization of the rubber element 13 along the circumference may not be constant for this purpose. A simple, practical embodiment for this may be a multi-polar magnetization of the rubber element 13 with alternating polarity, as shown in FIG. 2, where north poles and south poles are alternately arranged along the circumference of the shaft 10. In another embodiment, magnetized circumferential sections may alternate with non-magnetised circumferential sections. In yet another embodiment, a single magnetized rubber element 13 may suffice. The single magnetized rubber element 13 may extend only over a limited circumferential section of the shaft 10 and may be, for example, of the size of a single-pole region in FIG. 2. The rubber element 13 need not, therefore, be ring-shaped at all.

The recess 12 in the rod or shaft 10 may be practically adapted to the shape of the rubber element 13 so that an aligned surface in the region of the rubber element 13 may be obtained. The recess 12 need not, therefore, completely surround the shaft 10.

In the embodiment shown in FIG. 6, the rubber element 13 is arranged in a spiral around the circumferential wall of the rod or shaft 10. In this embodiment, both the axial position as well as the angle of rotation and/or the rotating speed of the rod or shaft 10 can be determined.

The rubber element 13 can be attached in different ways in the recess 12. In one embodiment, the rubber element 12 is attached in the recess 12 through vulcanising on or through gluing-in and/or pressing-in of a prefabricated profile ring 13.

The recess 12 can be rounded out to reduce notch stresses, as is visible for example from FIG. 1.

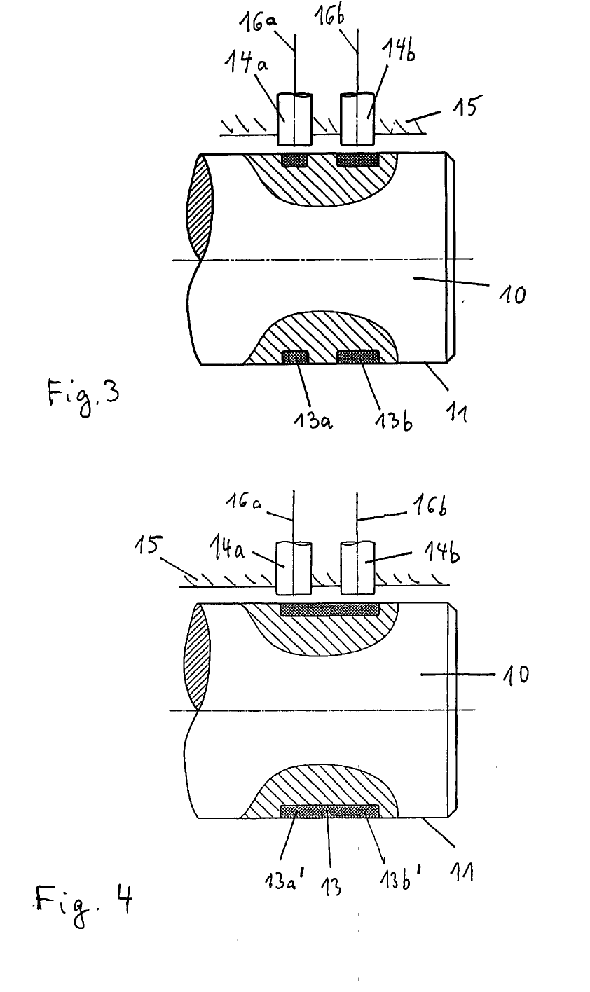

In the embodiment according to FIG. 3 a plurality of magnetized rubber elements 13a, 13b and a corresponding plurality of sensors 14a, 14b may be provided. This can be advantageous for the functional separation of the determination of the axial position and the determination of the rotary position of the shaft 10. In FIG. 3, the rubber ring 13a, for determining an axial position of the shaft 10, can be magnetized in a bipolar manner, for example as shown in FIG. 1, while the rubber ring 13b, for determining a rotary position of the shaft 10, can be magnetized in a multi-polar manner, for example as shown in FIG. 2.

The embodiment according to FIG. 4 makes it clear that, for example, the determination of the axial position and the determination of the rotary position of the shaft 10 does not require two separate rubber elements. Instead, this may be realized with a single rubber element 13 having differently magnetized axial regions 13a′, 13b′. The separate axially spaced rubber elements 13a, 13b, and the axially spaced regions 13a′, 13b′ may be collectively referred to herein as axially-spaced, position-defining areas.

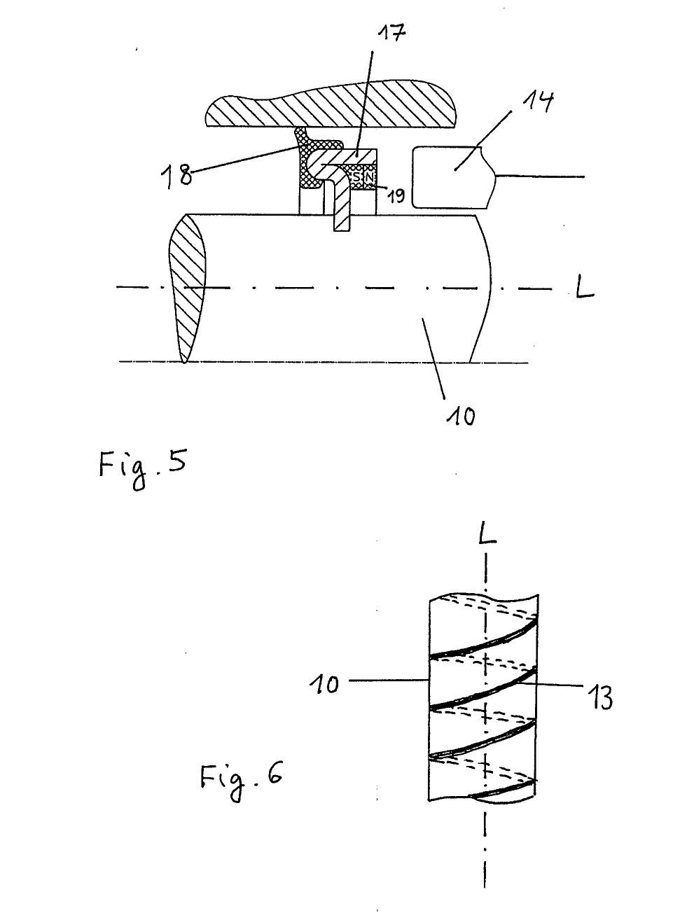

In yet another embodiment, an application with the shaft 10 rotating about the longitudinal axis L is shown in FIG. 5, wherein shaft 10 may comprise a composite piston 10 for an automated motor vehicle gearbox rotating about the longitudinal axis L. A support body 17 may support a dynamic seal 18 which may be vulcanised onto the support body 17. A magnetized rubber element 19 may be attached to the support body 17. The axial position, the angle of rotation, and/or the rotating speed of the composite piston may be securely determined despite high circumferential speeds with the sensor 14. The embodiment according to FIG. 5 makes it clear that the rubber element 19 need not necessarily be arranged on the component 10 or sunk into the component, but can be arranged on an intermediate piece, for example, support body 17, that may be attached to the component.

The invention has been described in detail with respect to exemplary embodiments above, and it will now be apparent from the foregoing to those skilled in the art, that changes and modifications may be made without departing from the invention in its broader aspects, and the invention. Therefore, as defined in the appended claims, the invention is intended to cover all such changes and modifications that fall within the true spirit of the invention.

What is claimed is:

1. A displaceable component, comprising:
a body having an axis and arranged for movement in at least one of an axial direction or a rotary direction about the axis; and
a position-defining element fixed to the body and substantially comprising a magnetised elastomer, the position-defining element being arranged to be sensed by a sensor to determine at least one of an axial position, a rotary position or a rotary speed of the body.

2. The component of claim 1, wherein the body comprises a groove to accommodate the position-defining element.

3. The component of claim 1, wherein the position-defining element is ring-shaped.

4. The component of claim 1, wherein the displaceable component is substantially rod-shaped.

5. The component of claim 1, wherein the displaceable component is a valve stem or valve tappet in a motor vehicle engine.

6. The component of claim 1, wherein the position-defining element is magnetized in a bipolar manner.

7. The component of claim 1, wherein the body is axially displaceable and the sensor determines the axial position of the body.

8. The component of claim 1, wherein the body is rotatable and the sensing element determines the rotary position of the body.

9. The component of claim 1, wherein the body is rotatable and the sensing element determines the rotating speed of the body.

10. The component of claim 1, wherein the position-defining unit is magnetized in a multi-polar manner.

11. The component of claim 1, wherein the displaceable component is a shifting piston for an automatic or automated gearbox.

12. The component of claim 1, wherein the position-defining element is arranged in a spiral about the displaceable component.

13. The component of claim 1, wherein the magnetized elastomer comprises ferritic particles.

14. A position determining system comprising:
a displaceable component including a position-defining element substantially comprised of a magnetized elastomer providing a magnetic field useful to determine at least one of an axial position, a rotary position or a rotating speed of the displaceable component; and
a sensing unit arranged proximate the displaceable component to sense the magnetic field of the position-defining element to determine at least one of the axial position, the rotary position, or the rotating speed of the displaceable component.

15. The position determining system of claim 14, wherein the position-defining element comprises a plurality of axially spaced position-defining areas each substantially comprised of a magnetized elastomer.

16. The position determining system of claim 15, wherein the sensing unit comprises a plurality of sensors each of which is operatively arranged to sense a respective one of the position-defining areas.

17. A method for manufacturing a displaceable component, wherein the displaceable component includes a position-defining element to determine a position of the displaceable component with the use of a sensor, wherein the position-defining element substantially comprises a magnetized elastomer, the method comprising:
shaping the elastomer; and
magnetizing the elastomer during the shaping.

18. A method for manufacturing a displaceable component, wherein the displaceable component includes a position-defining element to determine a position of the displaceable component with the use of a sensor, wherein the position-defining element substantially comprises a magnetized elastomer, the method comprising:
vulcanizing the position-defining element to the displaceable component; and
subsequently magnetizing the position-defining element.
